(19) United States
(12) Patent Application Publication
(10) Pub. No.: US 2016/0176158 A1
(43) Pub. Date: Jun. 23, 2016

(54) Non-Woven Fabric Containing Cotton And Method For Manufacturing Same

(71) Applicant: XIAMEN YANJAN NEW MATERIAL CO., LTD, Xiamen (CN)

(72) Inventors: Jihua Xie, Xiamen (CN); Jiquan Xie, Xiamen (CN)

(21) Appl. No.: 14/909,983

(22) PCT Filed: Aug. 8, 2013
(86) PCT No.: PCT/CN2013/081039

§ 371 Date: Feb. 3, 2016

(51) Int. Cl. B32B 7/02; D04H 1/425; D04H 1/4291; B32B 7/08; B32B 5/02; B32B 5/06; B32B 5/26; D04H 1/492; D04H 1/56

(52) U.S. Cl. CPC B32B 7/02; D04H 1/492; D04H 1/425; D04H 1/4291; D04H 1/56; B32B 5/022; B32B 5/06; B32B 5/26; B32B 7/08; B32B 2250/02; B32B 2250/20; B32B 2262/062; B32B 2262/0253; B32B 2307/718; B32B 2555/02; D10B 2201/02; D10B 2321/022; D10B 2509/026; D10B 2403/02

(57) ABSTRACT

Provided are a non-woven fabric containing cotton and a method for manufacturing same. The non-woven fabric containing cotton is composed of at least a surface layer and a non-woven fabric reinforcement layer, wherein the surface layer is composed of 30%-100% of cotton fibers in a gram weight of 5-30 g/m2, and the cotton fibers permeate the non-woven fabric reinforcement layer. The non-woven fabric containing cotton can not only maintain the advantages of softness and kindness to skin of the cotton fibers, but can also improve the strength of a spunlace non-woven fabric.

### BACKGROUND OF THE INVENTION

1. Field of the Invention

The present invention relates to a non-woven fabric and a method for manufacturing same, and more particularly to a non-woven fabric containing cotton and a method for manufacturing same. The non-woven fabric can be used as the face layer of an absorbent product.

2. Description of the Prior Art

These days, a non-woven fabric is widely used as the face layer of sanitary absorbent products, such as sanitary napkins, diapers and the like, which is a polypropylene spunbond non-woven fabric, a hot blast non-woven fabric, or a hot-rolled non-woven fabric. When the non-woven fabric functions as the face layer of absorbent products, it is close contact with the human body so the non-woven fabric must be soft, breathable and skin-friendly. The existing hot blast non-woven fabric, hot-rolled non-woven fabric and polypropylene spunbond non-woven fabric are soft, but a spunlace non-woven fabric is more softer and skin-friendly like the touch of cotton textiles. Compared to thin non-woven fabrics manufactured by other technology, the strength of the spunlacing non-woven fabric is not enough and it is deformed easily. The gram weight of the spunlace non-woven fabric must be great, or it will cause that the surface of a web is uneven. The hydrophilic spunlace non-woven fabric has the problems of flowing back and wet. A spunlace non-woven fabric composed of 100% cotton fibers is soft and skin-friendly, compared to other spunlace non-woven fabrics composed of a non-woven fabric and adhesive fibers, its cost is high and it cannot be carded easily. There are much cotton neps on the surface of the web. These disadvantages influence the use of sanitary products. Accordingly, the inventor of the present invention has devoted himself based on his many years of practical experiences to solve these problems.

### SUMMARY OF THE INVENTION

The primary object of the present invention is to provide a non-woven fabric containing cotton and a method for manufacturing same. The non-woven fabric containing cotton can not only maintain the advantages of softness and kindness to skin of the face layer of the non-woven fabric, but can also improve the strength of the spunlace non-woven fabric.

In order to achieve the aforesaid object, the non-woven fabric containing cotton of the present invention is composed of at least one surface layer and a non-woven fabric reinforcement layer. The surface layer is composed of 30%-100% of cotton fibers in a grain weight of 5-30 g/m2 The cotton fibers permeate the non-woven fabric reinforcement layer.

Preferably, the surface layer is in a gram weight of 5-20 g/m2.

Preferably, the cotton fibers are hydrophilic cotton fibers or hydrophobic cotton fibers.

Preferably, the surface layer includes 70%-100% of cotton fibers.

Preferably, the non-woven fabric reinforcement layer is one of a polypropylene spunbond non-woven fabric, a hot blast non-woven fabric, and a hot-rolled non-woven fabric.

Preferably, the non-woven fabric reinforcement layer is in a gram weight of 8-50 g/m2.

Preferably, the non-woven fabric reinforcement layer is in a grain weight of 10-30 g/m2.

Preferably, the surface layer is disposed on upper and lower surfaces of the non-woven fabric reinforcement layer.

A method for manufacturing a non-woven fabric containing cotton comprises the steps of:

step 1, carding and lapping 30%-100% of cotton fibers through a carding machine to form a surface layer to place flat on a surface of a non-woven fabric reinforcement layer;

step 2, performing one-sided or two-sided spunlacing process, the cotton fibers of the surface layer being consolidated on an upper surface of the non-woven fabric reinforcement layer or both upper and lower surfaces of the non-woven fabric reinforcement layer; and

step 3, drying and rolling the non-woven fabric after spunlaced to from the non-woven fabric containing cotton.

By the spunlacing technology, the cotton fibers and the nonwoven fabric of the present invention are bonded together. The surface layer contains cotton fibers to achieve the demand of softness, like the touch of cotton textiles. By the spunlacing technology, only a small amount of cotton fibers are needed to achieve the touch of a common spunlace non-woven fabric. This saves cotton fibers and lowers the cost. The arrangement of the non-woven fabric reinforcement layer makes the spunlace non-woven fabric have a certain breaking strength, particularly the longitudinal strength is able to bear the pulling force when the sanitary napkin machine is running so as to ensure a smooth working. The non-woven fabric containing cotton can be applied to the face layer of sanitary napkins, diapers and the like.

### BRIEF DESCRIPTION OF THE DRAWINGS

FIG. 1 is a schematic view of a first embodiment of the present invention;

FIG. 2 is a schematic view of a second embodiment of the present invention;

FIG. 3 is a block diagram showing the manufacturing procedures of the present invention; and

FIG. 4 is another block diagram showing the manufacturing procedures of the present invention.

### DETAILED DESCRIPTION OF THE PREFERRED EMBODIMENTS

Embodiments of the present invention will now be described, by way of example only, with reference to the accompanying drawings.

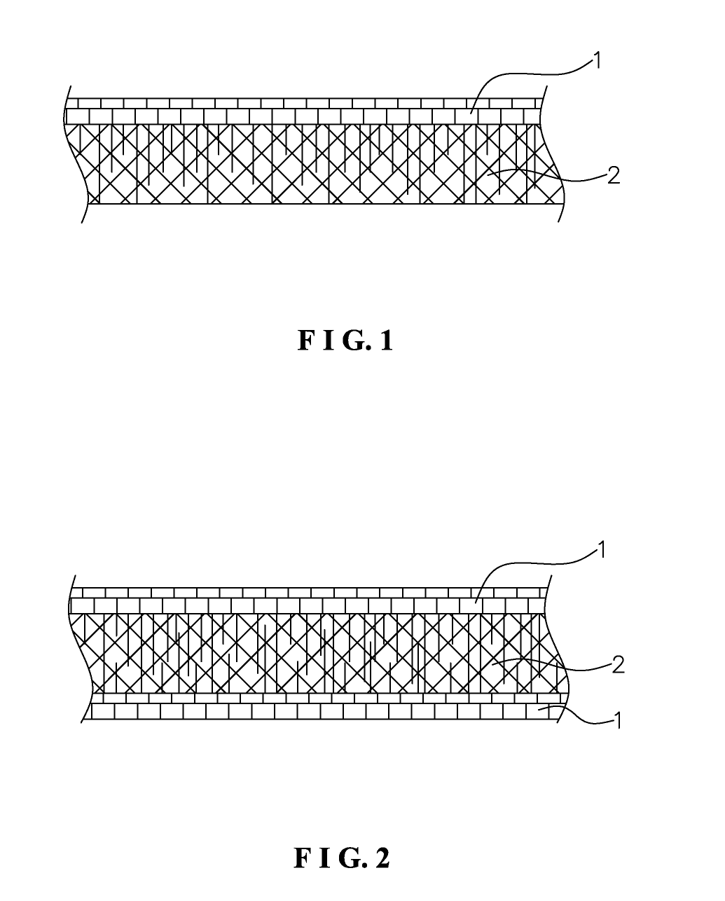

As shown in FIG. 1 through FIG. 4, the present invention discloses a non-woven fabric containing cotton and a method for manufacturing same. The non-woven fabric containing cotton is composed of at least one surface layer 1 and a non-woven fabric reinforcement layer 2. The surface layer 1 is composed of 30%-100% of cotton fibers in a grain weight of 5-30 g/m2 The cotton fibers permeate the non-woven fabric reinforcement layer 2. The surface layer 1 can be disposed on upper and lower surfaces of the non-woven fabric reinforcement layer 2, as shown in FIG. 2. The cotton fibers of the surface layer 1 can be hydrophilic cotton fibers or hydrophobic cotton fibers. Preferably, the surface layer 1 is in a gram weight of 5-20 g/m2 Preferably, the surface layer 1 is composed of 70%-100% of cotton fibers. The non-woven fabric reinforcement layer 2 is one of a polypropylene spunbond non-woven fabric, a hot blast non-woven fabric, and a hot-rolled non-woven fabric. The non-woven fabric reinforcement layer 2 is in a gram weight of 8-50 g/m2 Preferably, the non-woven fabric reinforcement layer 2 is in a gram weight of 10-30 g/m2

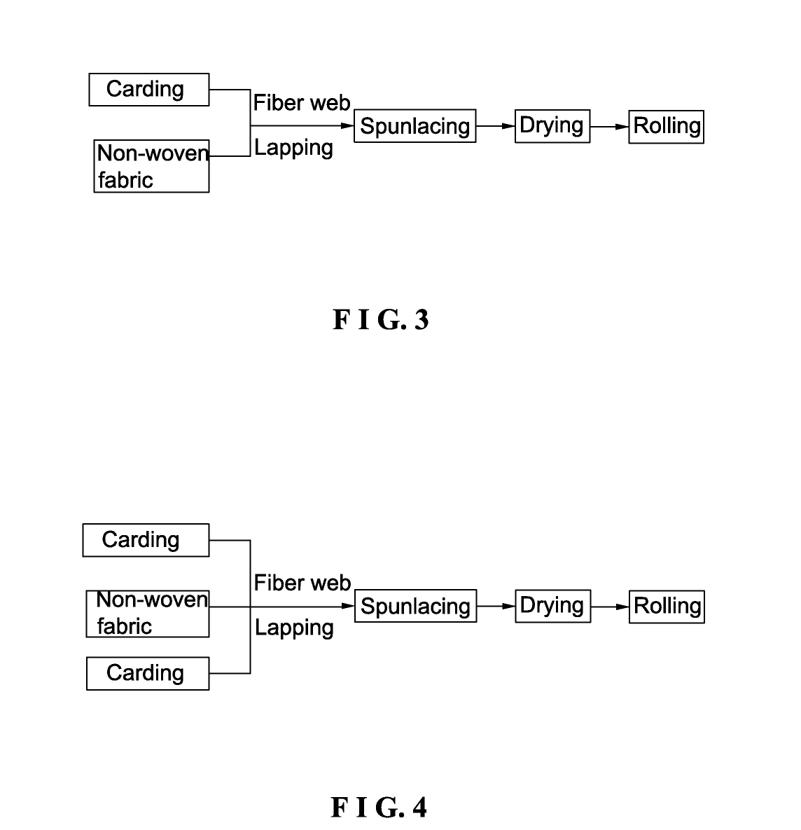

Referring to FIG. 3 and FIG. 4, the method for manufacturing a non-woven fabric containing cotton of the present invention comprises the steps of:

step 1, the cotton fibers of the surface layer 1 is first carded and lapped, and then the surface layer 1 is placed flat on the surface of the non-woven fabric reinforcement layer 2 through a carding machine. If the surface layer 1 is only disposed on the upper surface of the non-woven fabric reinforcement layer 2, only one layer of the cotton fiber surface layer 1 is carded (as shown in FIG. 3). If the surface layer 1 is disposed on the upper and surfaces of the non-woven fabric reinforcement layer 2, the cotton fibers of the upper and lower surface layers 1 are carded and placed flat on the non-woven fabric reinforcement layer 2 (as shown in FIG. 4);

step 2, performing one-sided or two-sided spunlacing process by high-speed jets of water to strike a fiber web in different directions for the fibers in the fiber web to insert, consolidate, entangle and knot about one another. Thus, the fibers of the surface layer 1 are consolidated on the non-woven fabric reinforcement layer 2; and

step 3, drying and rolling the non-woven fabric after spunlaced to from the non-woven fabric containing cotton.

By the spunlacing technology, the cotton fibers and the nonwoven fabric of the present invention are bonded together. The surface layer contains cotton fibers to achieve the demand of softness, like the touch of cotton textiles. By the spunlacing technology, only a small amount of cotton fibers are needed to achieve the touch of a common spunlace non-woven fabric. This saves cotton fibers and lowers the cost. The arrangement of the non-woven fabric reinforcement layer makes the spunlace non-woven fabric have a certain breaking strength, particularly the longitudinal strength is able to bear the pulling force when the sanitary napkin machine is running so as to ensure a smooth working. The non-woven fabric containing cotton can be applied to the face layer of sanitary napkins, diapers and the like.

Example 1, 10 gsm cotton fibers are carded and lapped through a carding machine to form a cotton fiber layer and then placed flat on the surface of a 10 gsm non-woven fabric. The non-woven fabric can be one of a hot blast non-woven fabric, a polypropylene spunbond non-woven fabric, and a hot-rolled non-woven fabric. By high-speed jets of water to strike a fiber web in different directions, the fibers in the fiber web insert, consolidate, entangle and knot about one another. Thus, the cotton fibers of the surface layer are consolidated on the non-woven fabric of the lower layer. After drying and rolling procedures, the upper layer of 10 gsm cotton fibers and the lower layer of 10 gsm non-woven fabric are bonded to form a spunlacing nonwoven fabric in a total weight of 20 gsm.

Through a XLW-100N smart electronic tensile testing machine to perform a tensile strength test, the test parameters are as follows:

width: 50 mm; length: 100 mm; tensile speed: 100 m/min

The test result is that:

| Sample title | Tensile strength (N/50 mm) |
|---|---|
| spunlace non-woven fabric, 20gsm | 15.5 |
| the non-woven fabric containing cotton | 27.3 |
| of the present invention, 20gsm | |

As can be seen from the above test data, the common spunlace non-woven fabric under the condition of a lower gram weight, its mechanical property is lower and the machine operation is bad so it is hard to be applied to hygiene products. So far, the common spunlace non-woven fabric is above 30 gsm to satisfy the demand of the machine operation. This increases the cost, and the application of hygiene products is restricted.

Because the spunlace non-woven fabric of the present invention is provided with the non-woven fabric reinforcement layer, its mechanical property is enhanced under the condition of the same grain weight to satisfy the demand of the machine operations. The surface of the spunlace non-woven fabric of the present invention has the same touch as a common spunlace non-woven fabric. The cost is decreased greatly because the gram weight of the cotter fiber layer is lower, so the present invention can be widely used to hygiene products.

Example 2, 100% hydrophobic cotton fibers are carded and lapped through a carding machine to form a 10 gsm cotton fiber layer, and then placed flat on the surface of a 15 gsm hydrophilic non-woven fabric. By high-speed jets of water to strike a fiber web in different directions, the fibers in the fiber web insert, consolidate, entangle and knot about one another. Thus, the cotton fibers of the surface layer are consolidated on the polypropylene spunbond non-woven reinforcement fabric. After drying and rolling procedures, the upper layer of 10 gsm hydrophobic cotton fibers and the lower layer of 15 gsm hydrophilic non-woven fabric are bonded to form a spunlacing nonwoven fabric in a total weight of 25 gsm.

The surface layer of the spunlacing nonwoven fabric is composed of 100% cotton fibers, which can be carded more easily. Only a small amount of cotton fibers are needed to achieve the touch of a common spunlace non-woven fabric. This saves the cotton fibers and lowers the cost. Compared to a spunlace non-woven fabric composed of a common non-woven fabric and adhesive fibers, the touch of the present invention is softer and it is more skin-friendly. The cotton fibers of the surface layer are hydrophobic cotton fibers. During use, when liquid flows to the surface layer of the spunlace non-woven fabric, the liquid permeates through the spunlace non-woven fabric to absorbers in a quick way under the action of gravity and the surface energy differential. Because the upper layer is hydrophobic and the lower layer is hydrophilic, the hydrophobic cotton fibers can block the liquid from flowing back to the surface layer of the spunlace non-woven fabric so as to provide a dry and comfortable surface layer. The mechanical property of the polypropylene spunbond non-woven fabric of the lower layer is better than that of a hot blast non-woven fabric and a hot-rolled non-woven fabric. The polypropylene spunbond non-woven fabric functions as the reinforcement layer of the spunlace non-woven fabric to enhance the mechanical property and to prevent deformation for machine operations. The non-woven fabric containing cotton can be applied to the face layer of sanitary napkins, diapers and the like.

Example 3, 100% cotton fibers or 30%-100% mixed cotton fibers are carded and lapped through two or more carding machines to form a 5-30 gsm cotton fiber layer, and then placed flat on the surface or the bottom of a non-woven fabric in a gram weight of 8-50 g/m2 At least one layer of cotton fibers is disposed on the surface layer of the non-woven fabric. The non-woven fabric reinforcement layer is one of a hot blast non-woven fabric, a polypropylene spunbond non-woven fabric, and a hot-rolled non-woven fabric. By high-speed jets of water to strike a fiber web in different directions, the fibers in the fiber web insert, consolidate, entangle and knot about one another. Thus, the cotton fibers of the surface layer are consolidated on the non-woven reinforcement fabric. After drying and rolling procedures, a multi-layer spunlacing nonwoven fabric containing cotton is formed.

The face layer of the spunlacing nonwoven fabric is a cotton fiber layer and has the touch of a cotton fabric. The reinforcement layer of the non-woven fabric can reinforce the strength, which is beneficial for machine operations and can save the cost of the spunlacing nonwoven fabric.

Although particular embodiments of the present invention have been described in detail for purposes of illustration, various modifications and enhancements may be made without departing from the spirit and scope of the present invention. Accordingly, the present invention is not to be limited except as by the appended claims.

What is claimed is:

1. Anon-woven fabric containing cotton, composed of at least one surface layer and a non-woven fabric reinforcement layer, the surface layer being composed of 30%-100% of cotton fibers in a grain weight of 5-30 g/m2, the cotton fibers permeating the non-woven fabric reinforcement layer.

2. The non-woven fabric containing cotton as claimed in claim 1, wherein the surface layer is in a gram weight of 5-20 g/m2.

3. The non-woven fabric containing cotton as claimed in claim 1 or 2, wherein the cotton fibers are hydrophilic cotton fibers or hydrophobic cotton fibers.

4. The non-woven fabric containing cotton as claimed in claim 3, wherein the surface layer includes 70%-100% of cotton fibers.

5. The non-woven fabric containing cotton as claimed in claim 1 or 2, wherein the non-woven fabric reinforcement layer is one of a polypropylene spunbond non-woven fabric, a hot blast non-woven fabric, and a hot-rolled non-woven fabric.

6. The non-woven fabric containing cotton as claimed in claim 5, wherein the non-woven fabric reinforcement layer is in a gram weight of 8-50 g/m2.

7. The non-woven fabric containing cotton as claimed in claim 6, wherein the non-woven fabric reinforcement layer is in a gram weight of 10-30 g/m2.

8. The non-woven fabric containing cotton as claimed in claim 1, wherein the surface layer is disposed on upper and lower surfaces of the non-woven fabric reinforcement layer.

9. A method for manufacturing a non-woven fabric containing cotton, comprising the steps of:
step 1, carding and lapping 30%-100% of cotton fibers through a carding machine to form a surface layer to be placed flat on a surface of a non-woven fabric reinforcement layer;
step 2, performing one-sided or two-sided spunlacing process, the cotton fibers of the surface layer being consolidated on an upper surface of the non-woven fabric reinforcement layer or both upper and lower surfaces of the non-woven fabric reinforcement layer; and
step 3, drying and rolling the non-woven fabric after spunlaced to from the non-woven fabric containing cotton.
